(19) United States
(12) Patent Application Publication
(10) Pub. No.: US 2008/0261041 A1
(43) Pub. Date: Oct. 23, 2008

(54) COMPOSITE FACERS, WALLBOARDS WITH PROTECTIVE COMPOSITE FACERS AND METHODS OF MANUFACTURE

(76) Inventors: Daron J. Thomas, Bakersfield, CA (US); Steven Judd, Bakersfield, CA (US); Michael Brian Lewis, Bakersfield, CA (US)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 12/105,533

(22) Filed: Apr. 18, 2008

Related U.S. Application Data
(60) Provisional application No. 60/925,766, filed on Apr. 23, 2007.
(60) Provisional application No. 60/942,871, filed on Jun. 8, 2007.

(51) Int. Cl. D02G 3/02; D02G 3/44; B29C 71/00

(52) U.S. Cl. 428/359; 428/373; 264/347

(57) ABSTRACT

Composite facers used for the top and/or bottom facings of wallboard cores, with the facers made from resin impregnated synthetic veils and randomly oriented glass fiber reinforcements, wallboard made with the composite facers, and methods of manufacture of the facers and of the wallboard.

### RELATED APPLICATIONS

The present application is related to, claims the benefit of priority on and incorporates by reference application 60/925,766, filed Apr. 23, 2007, and application 60/942,871, filed Jun. 8, 2007.

### FIELD OF INVENTION

The invention relates generally to wallboards, novel composite facers for use in wallboard manufacture and methods of manufacture.

### BACKGROUND OF INVENTION

Wallboards are well known products in the building construction industry. Wallboards are also typically known as gypsum boards and/or cement boards. These products typically include a set gypsum core and/or a cementitious core having a facing on the top and/or on the bottom surfaces. Conventional facings include paper, drywall mud, and fiberglass mat. Various configurations are known and various additives can be included in the products to provide specific functions, such as enhancing water resistance, mold resistance, etc. Specific wallboard products and methods of manufacture are described in numerous publications, including, for example, U.S. Pat. Nos. 6,770,354 (“the '354 patent”); 5,319,900 (“the '900 patent”); 6,808,793 (“the '793 patent”); 4,647,496 (“the '496 patent); 5,342,680 (“the '680 patent”); 5,220,762 (“the '762 patent”); and 6,838,163 (“the '163 patent”).

Paper and drywall mud are relatively inexpensive, conventional facing materials used in the process of manufacturing wallboard. However, moisture can have deleterious effects upon paper-faced and mud-faced wallboard. In addition to degrading strength and other structural properties, moisture, alone or in combination with other factors can encourage the growth of fungi, including, e.g., molds that are harmful to human health.

As an alternative to drywall mud or paper facing, wallboard can also be manufactured with fiberglass mats, such as described in above-identified patents. These fiberglass mats are embedded in the top and/or bottom faces of the wallboard core. In addition to improved water resistance, wallboards having fiberglass mat facings often provide significant improvements in strength and other desired structural characteristics.

Although such fiberglass mat facings may be more advantageous than paper facings or drywall mud facings, particularly with respect to their moisture resistance for exterior applications, they are less desirable than paper or mud facings in other respects. In particular, due to their generally more irregular or rough surface, wallboards having fiberglass mat facings have relatively rough surfaces, and are therefore, in many applications, not as suitable for finishing as are wallboards having paper or mud facings. Interior walls, for example, are often finished with paint or wallpaper. While wallboards having paper facings offer a smooth surface for painting or papering, the wallboards having fiberglass mat facings do not. Attempts to address this problem have included putting a relatively thin, mud layer on the outer surface of the top and/or bottom facings of wallboard.

Another problem with fiberglass mat facings on wallboards is that when the wallboard is cut and scored to the desired lengths it releases fiberglass particles into the air stream, and thus causing potential respiratory problems, and skin and eye irritation. It has been discovered that scoring and cutting wallboard made with the composite facers described herein does not release any significant fibers into the air stream. Thus, in comparison to conventional wallboard, the wallboard described herein reduces and/or eliminates potential respiratory problems, eye and skin irritation that are associated with conventional fiberglass mat wallboard facings. Also, the composite facers and wallboards described herein essentially eliminate the “itchiness and irritation” normally associated with conventional fiberglass mat wallboard facings and wallboards made with such facings.

### SUMMARY OF INVENTION

The composite facers described herein may be used to manufacture wallboard having a protective and smooth surface, and that is essentially free of the fiberglass migration problem as found in conventional wallboards having fiberglass mat facings. The present composite facers include a synthetic veil made of a (i) polypropylene, polyester and/or polyamide (nylon), (ii) glass fiber reinforcements, and (iii) binder or resin. These ingredients form a composite facer that is then attached, preferably top and bottom to a wallboard core to form a finished wallboard. The resulting wallboard has a surface that is smooth enough to permit painting or wall papering directly on the wallboard facer surface.

The most preferred veil is a spun-bonded, polyester flat bond synthetic veil. The preferred veil is available from Fiberweb, LLC, and has a weight in the range of 0.40 ounces to 4.0 ounces per square yard, with lower weights being most preferred. The preferred fibers in the veil are nylon, polyester, and other man-made fibers such as rayon and others.

Once formed or manufactured as described below, the finished composite facer is then adhered to a wallboard core in a conventional process, similar to that as described for example, in U.S. Pat. No. 6,808,793, to manufacture a finished wallboard.

One object of the composite facers and methods of manufacture described herein is to provide a composite facer that may be used to manufacture wallboard.

Another object is to provide a wallboard having a smooth, composite surface suitable for painting or wallpapering without a need or requirement to apply a smooth coat of mud on the surface in order to render the surface smooth enough for direct application of paint or wallpaper.

Another object is to provide a composite facer having the ability to repel water from the finished wallboard composite facer. Such water repellency will enable the wallboard to be exposed to moisture with no additional treatment.

A further object is to provide a composite facer having the ability to impart to wallboard protection from mold and other agents. The composite facer may be treated with an anti-microbial agent or fungicide.

Composite facers described herein provide a smooth and protective facing for wallboard that can be exposed to moisture, mold and other agents and can be painted on directly, thereby eliminating the need for drywall mud or paper facing or fiber glass mat.

These and other embodiments, features, aspects, and advantages of the composite facers described herein will become better understood with regard to the following description, appended claims and accompanying drawings.

### BRIEF DESCRIPTION OF THE DRAWINGS

The foregoing aspects and the attendant advantages of the present invention will become more readily appreciated by reference to the following detailed description, when taken in conjunction with the accompanying drawings, wherein:

FIG. 1 is a schematic diagram illustrating a preferred embodiment of a sub-system for preparation of a slurry used to make embodiments of the present composite facers;

FIG. 2 is a schematic diagram illustrating a preferred embodiment of a sub-system for forming preferred embodiments of the present composite facers;

FIG. 3 is a schematic diagram illustrating a preferred embodiment of a sub-system for drying and inspecting preferred embodiments of the present composite facers;

FIG. 4 is a schematic diagram illustrating a preferred embodiment of a sub-system for placing preferred embodiments of the present composite facers on rolls;

FIG. 5 is a schematic drawing illustrating the layered components of a conventional coated fiberglass faced wallboard; and,

FIG. 6 is a schematic drawing illustrating the components of a preferred embodiment of the presently described wallboard.

Reference symbols or names are used in the Figures to indicate certain components, aspects or features shown therein. Reference symbols common to more than one Figure indicate like components, aspects or features shown therein.

### DETAILED DESCRIPTION

### Composite Facer Compositions

Preferred embodiments of the present invention composite facers include a synthetic veil, to which randomly oriented glass fiber reinforcements are bonded with a resin or binder. Preferred embodiment veils are polypropylene, polyester, polyamide (nylon). The preferred veils weigh from about 0.40 ounces to 4.0 ounces per square yard, with the most preferred being in the lower part of the range. Alternatively, acrylic, polypropylene, polyvinyl chloride, polytetrafluoroethylene, polyphenylene sulfide, and polyphenylene sulfone may be used for veils. The most preferred veil is a spun-bonded, polyester flat bond synthetic veil that is commercially available from Fiberweb LLC, as its Diamondweb™ brand polyester veil, available in various weights ranging from 0.40-4.00 ounces per square yard, in various thicknesses ranging from 6-38 mils, and available from Fiberweb LLC, 70 Old Hickory Blvd., Old Hickory, Tenn. 37138. Veil products traditionally have a weight under 1.4 pounds per 100 square feet. In contrast, mats are heavier, with the most commonly used roofing mats, generally made of fiberglass, having a weight of 1.85 pounds per 100 square feet. When used in wallboards, the most commonly used mat is fiberglass mat weighing 2.0 to 2.5 pounds per 100 square feet. Also, as is well known, veil products lack the tensile or tear strengths that mats have, and veils do not have the dimensional stability that mats have. Veil products are typically used in combination with other products while mats are generally used as stand alone products. Also, veils products are relatively more open and porous than mat products, which are known to be more closed and less porous.

The preferred embodiments of the presently described composite facers include glass fiber reinforcements, preferably in lengths in the range about 0.25 inches to 2.00 inches having a fiber diameter of 8-21 microns. These glass fiber reinforcements are commercially available from Owens Corning, PPG, Saint Gobain, Johns Manville and others.

The most preferred resin, or, as it is also commonly known in this field, a binder, is a thermosetting, urea formaldehyde (UF) resin having significant water tolerance, commercially available as types Casco-Resin FG-118, UF 118, 118A and 118B from Hexion Specialty Chemicals (“Hexion”), 180 East Broad Street, Columbus, Ohio 43215, or 155 West A Street, Bldg., A-1, Springfield, Oreg. 97477. The differences between the FG-118, UF 118, UF 118A and UF 118B are believed to relate to the ingredients providing for different cure times. Alternatively, RHOPLEX™ brand emulsion resins, available from Rohm and Haas, 100 Independence Mall West, Philadelphia, Pa. 19106-2399, as its TR-407 emulsion and GL-618 emulsion can be used. Another useful binder is PF resin IB 588A, available from Hexion Specialty Chemicals.

Numerous materials may be added to the resin to achieve desired properties, as is well know in this field. Preferred additives include anionic acrylic wax, available as Michelman® brand, ME 00240 wax; anionic paraffin/polyethylene wax, available as Michelman® brand, ML 368 wax; acrylic resin, available as Rhoplex™ brand GL 720 emulsion; chlorinated paraffin adhesive, available as Fosters® brand 7060 adhesive; melamine resin (MF), available as Cascomel® brand SR 707X resin; methylated melamine resin (MF), available as Astro® brand Mel NW 3A resin; silicone emulsion, available as Dow Corning® 1101 emulsion; aluminum hydroxide, antimony trioxide and talc.

Embodiments of the preferred finished composite facers of the present invention are relatively thin sheets that are typically provided in industry standard widths of 47.25 inches or 50.50 inches, and in rolls of variable length. Other, custom widths, up to 110 inches can be provided. Typically, the maximum roll diameter is 59 inches with a 6-inch ID core, which translates into roll lengths typically ranging from 5,000 feet to 6,500 feet, depending on the weight and thickness of the composite facer. In this field the weight characteristic is generally referred to as a weight per 100 square feet. Thus, a fiber glass mat facing material referred to as 2-pound facer, would weigh 2 pounds per 100 square feet. The presently most preferred embodiment of the presently described composite facers has a weight of about 2.5 to 3.5 pounds per 100 square feet. It is believed that composite facers made as described herein and having weights in the range of about 2.5 to about 6.0 pounds per 100 square feet will be useful for the intended purpose of manufacturing wallboard. In comparison to the conventional, fiberglass mat-faced wallboard, wallboard made as described herein is relatively light, due primarily to the difference in weight of the synthetic veil used herein, as compared to the fiberglass mat with a heavy coating added on top of it as used in conventional wallboard. It is a combination of the heavy fiberglass mat and the heavy coating that makes the prior art facers so much heavier than the facers described herein. In the prior art facers, the coating and the mat are essentially equal partners in making that product so heavy. Also, it has been discovered that if a synthetic mat or veil is used alone as a facer, it will tear, wrinkle, fold, crease and/or shrink when attempting to coat it. Also, if a synthetic mat or veil alone is used as a facer, it lacks dimensional stability sufficient to coat it and form a core on it. If used alone as a facer, a synthetic mat or veil will exhibit significant bleed through during wallboard manufacture. It has been discovered that the combination synthetic veil and glass fiber reinforcement based facers described herein provide dimensional stability sufficient for a useful wallboard product. Together with the veil, the glass fiber reinforcements are believed to provide the dimensional stability necessary to prevent the veil from tearing, wrinkling, folding, creasing or shrinking during wallboard manufacture or use. Additionally, the combination of the two, i.e., the resin-impregnated synthetic veil and glass fiber reinforcement based facer is a sealed product, that is, it is a closed sheet that prevents significant bleed through of core slurry during wallboard manufacture.

### Embodiments of Processes and Systems for Making Embodiments of Composite Facers

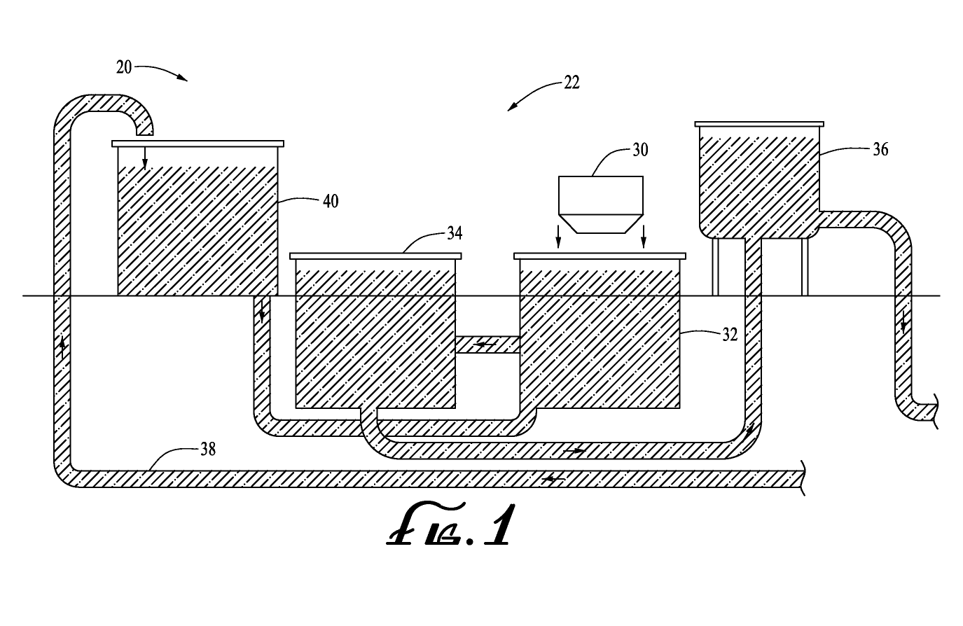

Referring to FIGS. 1-4 a preferred system 20 for making the composite facers includes a slurry mixing sub-system 22, a composite facer forming sub-system 24, a drying and inspection sub-system 26 and a roll forming sub-system 28. FIG. 1 shows the slurry mixing sub-system 22 including a raw fiber batch dump tank 30 into which raw glass fiber reinforcements are placed. The raw glass fiber reinforcements are then dumped into dispersion tank 32 where they are dispersed in a water mixture that includes slurry that is fed back from the facer forming sub-assembly 24. The dispersed reinforcements flow into the slurry holding tank 34 and from there are pumped (pump not shown) into a raised constant level tank 36. Slurry from the facer forming sub-system 24, referred to as “whitewater” due its generally white appearance, is returned via pipe 38 to whitewater storage tank 40. The whitewater is then sent from tank 40 to the dispersion tank 32, so that the glass fiber reinforcements not used in the backing forming sub-assembly can be re-supplied for forming a backing. Conventional tanks, pipes and pumps may be used for the slurry forming part of the system and process. Conventional line metering and control systems, often conventionally referred to as a gauging scanner, and techniques are used to measure the ingredients supplied to the system to establish and maintain the desired weights of binder, glass fiber reinforcements and other additives to yield a composite facer having the desired weight and other properties. For example, a lesser concentration of materials would be used to manufacture composite facer having weights near the low end of the 2.5 to 6.0 pounds per 100 square feet range referred to above, and a greater concentration of materials would be used to manufacture composite facer having weights near the high end of the range.

Making the preferred facings includes pouring raw glass fiber reinforcements into the dispersion tank and thoroughly mixing them using conventional additives such as dispersing agents, for example Schercapole DS 140 NF brand modified ethoxylated alkyl amine isopropanol, available from Noveon, Inc., 9911 Brecksville Rd., Cleveland, Ohio 44141-3247; and surfactants such as Foam Blast™ 327 brand multipurpose foam control liquid, available from Emerald Performance Materials, LLC, 311 Cleveland Place, Cheyenne, Wyo. 82007, and SUPERFLOC® A-130 anionic polyacrylamide flocculant available from Cytec Industries Inc., Five Garraet Mountain Plaza, West Patterson, N.J. 07424. The glass fiber reinforcements and the additives are thoroughly mixed using conventional equipment and conventional techniques to form a slurry.

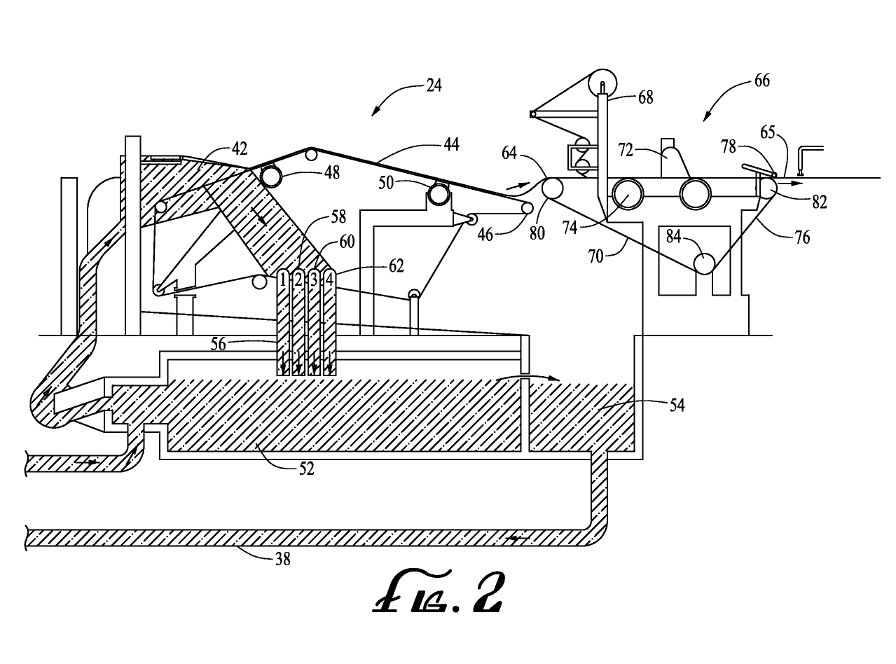

Referring to FIG. 2, the slurry is then pumped to a conventional spreading tank 42, which is adapted to have slurry overflow onto a continuously moving screen. The slurry is then spread out evenly over and across a conventional, moving belt screen 44, also referred to as a “delta” forming screen. Some of the glass fiber reinforcements will flow through the screen and be returned to the slurry forming sub-system as described above, and some of the glass fiber reinforcements will be retained on the screen 44 to form a thin web 64, and then will continue on to form the composite facer. As shown in FIG. 2, the screen 44 is of a continuous belt type, and is rotated with conventional techniques around a series of rollers, one of which is identified at 46. High velocity vacuums 48, 50 assist in forming the web. The slurry flows down to tanks 52, 54 via reclaim tubes 56, 58, 60 and 62. As the screen and its glass fiber reinforcements-laden slurry moves, the liquid portion of the slurry drains through the screen, leaving the thin web 64 of randomly oriented glass fiber reinforcements on the screen 44. The web 64 then continues moving on the screen 44 until it reaching the resin or binder applicator sub-assembly 66.

Again referring to FIG. 2, the binder applicator sub-assembly 66 includes a veil roll unwinding mechanism 68, a continuously moving binder or resin applicator screen 70, binder applicator 72, binder vacuums 74, 76, resin press or smoothing roller 78 and rollers 80, 82 and 84. During operation, the thin web 64 moves along the applicator roller, and the veil from the roll, as it is unwound, is laid over the thin web. Downstream at the binder applicator 72 a pre-determined amount of resin is poured over the veil and the thin web 64 to form a resin impregnated web and veil 65 that, upon curing and drying, becomes the composite facer. The resin impregnated web and veil 65 is then passed between the press roller 78 and roller 82, at which time the resin is uniformly spread about and forced through the resin impregnated veil and thin web 65.

The press or spreader roller 78 is placed in the production line downstream of the binder applicator and on the head roll 82 of the application or saturator screen 70. Preferably, a 4-inch diameter stainless steel roller, having bearing inserts on stationary shafts, and a pneumatic pressure control capability is used to provide for pressure control. This roller and the pneumatic adjustment capability function to evenly distribute the resin and to minimize wrinkling of the resin impregnated thin web and synthetic veil 65.

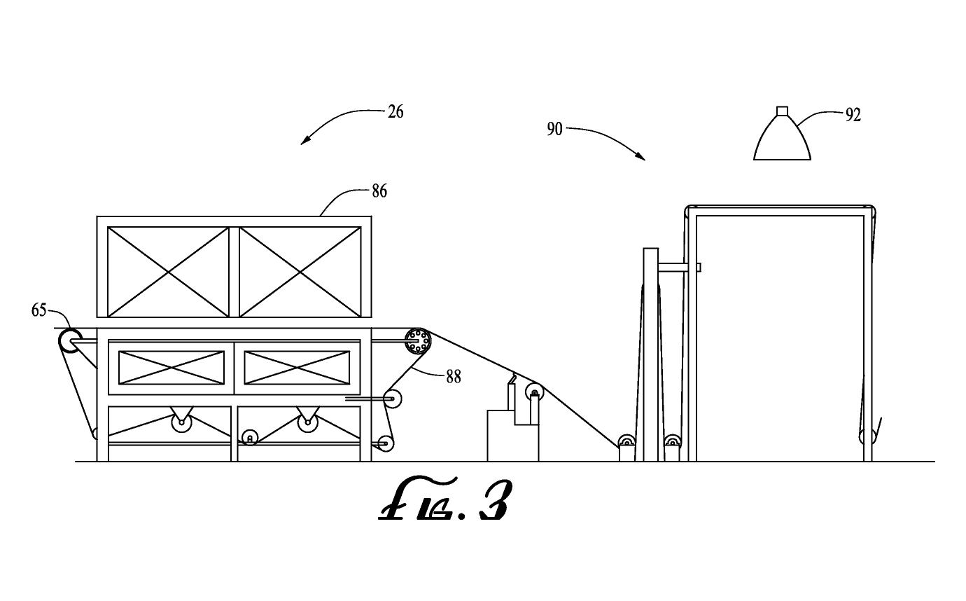

Referring to FIG. 3 the drying and inspection sub-system 26 is shown with a conventional dryer oven 86. As the resin impregnated web/veil 65 passes from the press roller 78 it is transferred to a continuous screen 88 on conventional rollers and then into the oven dryer section where the resin is set using conventional heaters and in a conventional fashion. The dried and resin-set web/veil 65 forms the composite facer. The composite facer is then passed to the web guide section 90, via conventional rollers and a support structure, and where it moves under an inspection lamp 92 so that it may be inspected for defects.

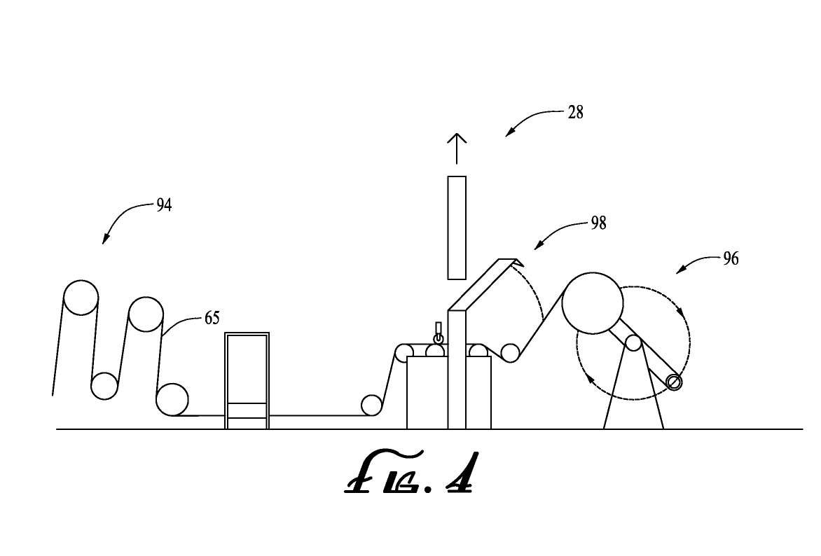

Referring to FIG. 4, the inspected composite facer is then passed on to the roll forming sub-assembly 28 via tension rollers 94 to the rotating twin mandrill winder. Between the rollers 94 and the mandrill 96 a splitter and trim removal sub-assembly 98, including a chopping knife and an edge trim vacuum is provided to cut the composite facer and remove the particles that are left at the edges.

The finished composite facers as described above and made in a desired weight are then used in the manufacture of wallboard. In conventional fashion, dry ingredients from which the wallboard core is formed are pre-mixed and then fed to a mixer of the type commonly referred to as a pin mixer. Water and other liquid constituents, such as soap, used in making the core are metered into the pin mixer where they are combined with the desired dry ingredients to form aqueous wallboard slurry. Foam (soap) is generally added to the slurry in the pin mixer to control the density of the resulting core. The slurry is dispersed through one or more outlets at the bottom of the mixer onto a moving sheet, which is indefinite in length and is fed from a roll thereof onto a forming table and advanced by conveyor. A finished composite facer of the present invention is then adhered to the top and to the bottom of the wallboard core. The slurry penetrates into the porous composite facer, but does not penetrate through the entire composite facer. On curing or setting, a strong adherent bond is formed between the wallboard core and the top and bottom composite facers.

When conventional wallboard is scored and cut to desired sizes at construction sites, significant fibers are released to the atmosphere, and are sources of eye and skin irritation, respiratory problems. This problem is well known in the field and is commonly referred to as fiberglass “migration”. In contrast, when wallboard made with the presently described synthetic facers is scored and cut, virtually no fibers or particles are released into the atmosphere. Thus, in comparison to the conventional fiberglass faced wallboard, the presently described wallboard is essentially free of the migration problem associated with conventional fiberglass faced wallboard.

Additional differences between the facers, wallboard and methods of manufacture described herein, in comparison to conventional fiberglass mat facer type wallboard and its manufacture are significant. In conventional fiberglass wallboard manufacture, finished fiberglass mat is purchased from a fiberglass mat supplier. While fiberglass mats are available in a wide range of weights, for use in wallboard, such mats typically have a weight of about 2.0 to 2.5 pounds per 100 square feet. The fiberglass mat is then typically processed by a vendor who remounts the mat on an unwind apparatus, and then unwinds and further processes the mat by sending it through one or more coating steps and coating apparatuses, and then drying or curing the coated mat to form the facer, i.e., the product that in turn is used to form the top and bottom surface of the wallboard. The conventional finished facer, that is, the fiberglass mat with the coating(s) typically weighs 5.0 to 6.0 pounds per 100 square feet. In comparison, the preferred synthetic veil used in making the facers described herein weighs less than the typical fiberglass mat used in conventional wallboard. The preferred synthetic veil used in the facers described herein weighs about 0.40 pounds per 100 square feet. To this relatively light product glass fiber reinforcements are impregnated with a resin and then dried or cured to form a finished facer product that can be used to make wallboard. This product does not have and does not use fiberglass mat. The preferred finished facer, i.e., the cured synthetic veil and glass fiber reinforcement product, weighs in the range of about 2.5 to 4.0 pounds per 100 square feet, representing about a 33% to 50% reduction in weight, but having dimensional stability sufficient to be used as wallboard facer.

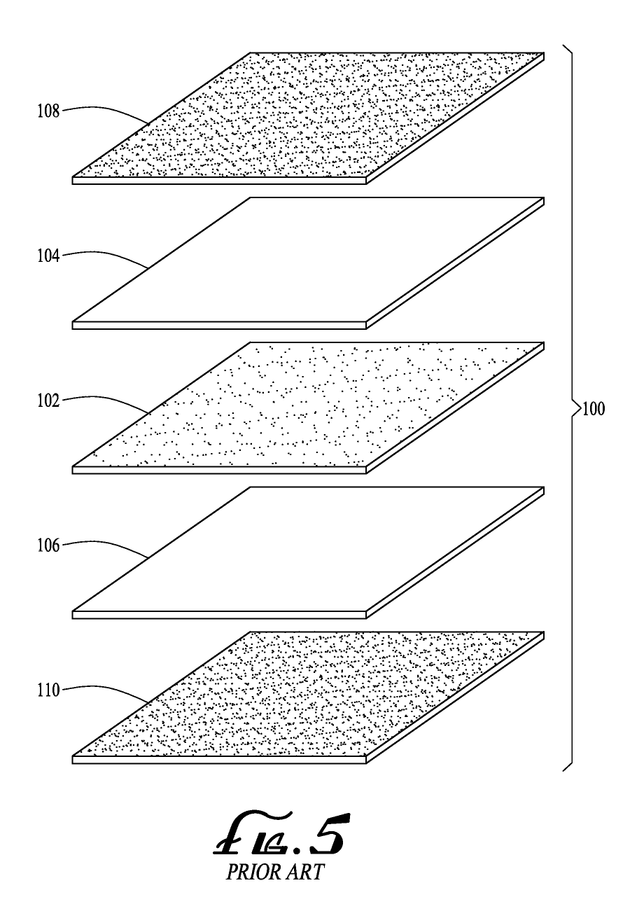

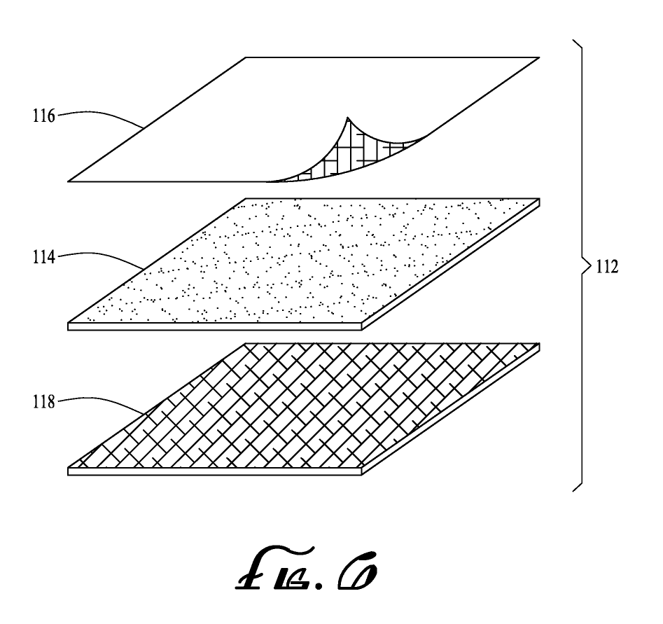

With reference to FIGS. 5 and 6 prior art, coated fiberglass faced wallboard (FIG. 5) and a preferred embodiment wallboard (FIG. 6) of the present invention will be described and compared. A typical prior art coated fiberglass faced wallboard 100 is shown in FIG. 5, and includes a gypsum core 102. Typically, the core 102 is sandwiched between a top fiberglass mat 104 and a bottom fiberglass mat 106. The fiberglass mats typically range from 2 to 2.5 pounds per 100 square feet. Also, typically a top coating 108 and a bottom coating 110 are applied to the fiberglass mats 104 and 106. The top and bottom coatings typically have weights in the range of 2.5 to 3.5 pounds per 100 square feet. Finished prior art coated fiberglass faced wallboard typically has a weight of 5.0 to 6.0 pounds per 100 square feet. As shown in FIG. 6 a preferred embodiment wallboard 112 includes a gypsum core 114 sandwiched in between a top fiber-reinforced synthetic veil 116 and a bottom fiber-reinforced synthetic veil 118. The synthetic veils typically have weights in the range of 0.4 to 0.5 pounds per 100 square feet, and the total weight of the wallboard 112 is in the range of 2.5 to 3.5 pounds per 100 square feet.

Although specific embodiments of the invention have been described, various modifications, alterations, alternative constructions, and equivalents are also encompassed within the scope of the invention. The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A method for making a composite wallboard facer comprising:
providing glass fiber reinforcements having lengths in a range of from about 0.25 inch to about 2.00 inches;
providing a thermosetting, urea formaldehyde resin;
providing a spun-bonded, polyester flat bond synthetic veil having a weight in a range of about 0.40 ounces to 1.4 ounces per square yard;
forming a slurry containing said glass fiber reinforcements;
forming from said slurry a web of glass fiber reinforcements;
placing the web of glass fiber reinforcements and the synthetic veil adjacent to each other to form a glass fiber reinforcement and synthetic veil pre-facer;
impregnating the pre-facer with said resin; and,
curing said resin to form the composite wallboard facer.

2. A composite wallboard facer comprising:
a web formed of glass fiber reinforcements having lengths in a range of from about 0.25 inch to about 2.00 inches;
a spun-bonded, polyester flat bond synthetic veil having a weight in a range of about 0.40 ounces to 1.4 ounces per square yard; and,
the web and the veil positioned adjacent each other and adhered to each other by a thermoset, urea formaldehyde resin.

3. A wallboard comprising:
a gypsum core having a top facer and a bottom facer;
the top facer comprising glass fiber reinforcements adhered to a synthetic veil; and,
the bottom facer comprising glass fiber reinforcements adhered to a synthetic veil.

4. A wallboard facer comprising:
a top facer comprising glass fiber reinforcements adhered to a synthetic veil; and,
a bottom facer comprising glass fiber reinforcements adhered to a synthetic veil.
